(19) United States
(12) Patent Application Publication
(10) Pub. No.: US 2006/0291534 A1
(43) Pub. Date: Dec. 28, 2006

(54) Cooling stirrer

(76) Inventor: Spero Pavlos, Willow Springs, IL (US)

Correspondence Address: BACON & THOMAS, PLLC, 625 SLATERS LANE, FOURTH FLOOR, ALEXANDRIA, VA, 22314, US

(21) Appl. No.: 11/157,839

(22) Filed: Jun. 22, 2005

(51) Int. Cl. G01K 7/00; G01K 1/08; G01K 1/00

(52) U.S. Cl. 374/165; 374/141; 374/208

(57) ABSTRACT

A cooling stirrer has a heat-conductive rod and an adiabatic handle. The heat-conductive rod has an upper end, a lower end, an upper section and a lower section. The adiabatic handle is hollow and is mounted on the heat-conductive rod. When the cooling stirrer is used to stir in a cup of hot beverage, the adiabatic handle prevents the user from scalding and the heat-conductive rod absorbs the heat of the hot beverage to cool the hot beverage.

### BACKGROUND OF THE INVENTION

1. Field of the Invention

The present invention relates to a stirrer, and more particularly to a cooling stirrer that cools a hot liquid in a container when the stirrer used to stirring the hot liquid.

2. Description of Related Art

Stirrers such as plastic or wooden rods are used generally to stir hot beverages such as coffee or tea when people want to make the dissolvable additive in the beverage such as sugar or powdered milk dissolve more quickly.

A luminous drink stirrer has been developed with a decorative characteristic. The luminous drink stirrer has a transparent rod, multiple colored illuminants, a circuit and a power source. The colored illuminants radiate with different colors in the transparent rod when the luminous drink stirrer is used. The radiated illuminants of the luminous drink stirrer provide an attractive visual effect.

However, the stirrers above are only used to improve the dissolution of the additive in the beverage and cannot be used to significantly cool a hot beverage.

To overcome the shortcomings, the present invention provides a cooling stirrer to mitigate or obviate the aforementioned problems.

### SUMMARY OF THE INVENTION

The main objective of the invention is to provide a cooling stirrer that cools a hot liquid in a container when used to stir the hot liquid.

A cooling stirrer in accordance with the present invention comprises a heat-conductive rod and an adiabatic handle.

The heat-conductive rod has an upper end, a lower end, an upper section and a lower section.

The adiabatic handle is hollow and is mounted on the heat-conductive rod.

Other objectives, advantages and novel features of the invention will become more apparent from the following detailed description when taken in conjunction with the accompanying drawings.

### BRIEF DESCRIPTION OF THE DRAWINGS

FIG. 1 is a cross sectional view of a first embodiment of a cooling stirrer in accordance with the present invention;

FIG. 2 is a perspective view of a second embodiment of a cooling stirrer in accordance with the present invention;

FIG. 3 is a cross sectional view of the cooling stirrer in FIG. 2;

FIG. 4 is a cross sectional view of a third embodiment of a cooling stirrer in accordance with the present invention;

FIG. 5 is a cross sectional view of a fourth embodiment of a cooling stirrer in accordance with the present invention.

FIG. 6 is a cross sectional view of a fifth embodiment of a cooling stirrer in accordance with the present invention; and

FIG. 7 is a cross sectional view of a cup of beverage with the cooling stirrer in FIG. 2 in the hot beverage.

### DETAILED DESCRIPTION OF PREFERRED EMBODIMENT

A cooling stirrer in accordance with the present invention comprises a heat-conductive rod for quickly absorbing the heat of a hot beverage and an adiabatic handle for fingers to grasp the handle. The heat-conductive rod has an upper end, a lower end, an upper section, a lower section and a temperature. The adiabatic handle is hollow and is mounted on the heat-conductive rod.

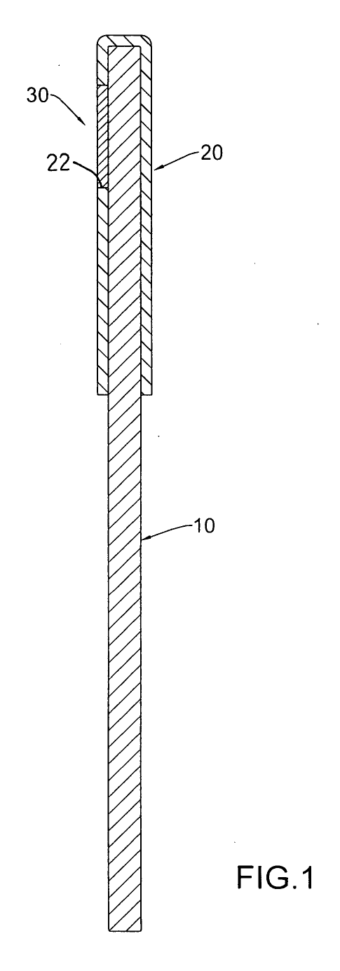

With reference to FIG. 1, a first embodiment of the cooling stirrer in accordance with the present invention comprises a heat-conductive rod (10), an adiabatic handle (20) and a thermometer (30). The heat-conductive rod (10) is made of inert metal that does not react with beverages and has an upper end, a lower end, an upper section and a lower section. The adiabatic handle (20) is hollow, is made of wood or plastic, is mounted around the upper section of the heat-conductive rod (10) and has a mounting hole (22). The mounting hole (22) is defined through the adiabatic handle (20) and is located on the upper section of the heat-conductive rod (10). The thermometer (30) is mounted through the adiabatic handle (20), contacts the heat-conductive rod (10), and senses and displays the temperature of the heat-conductive rod (10).

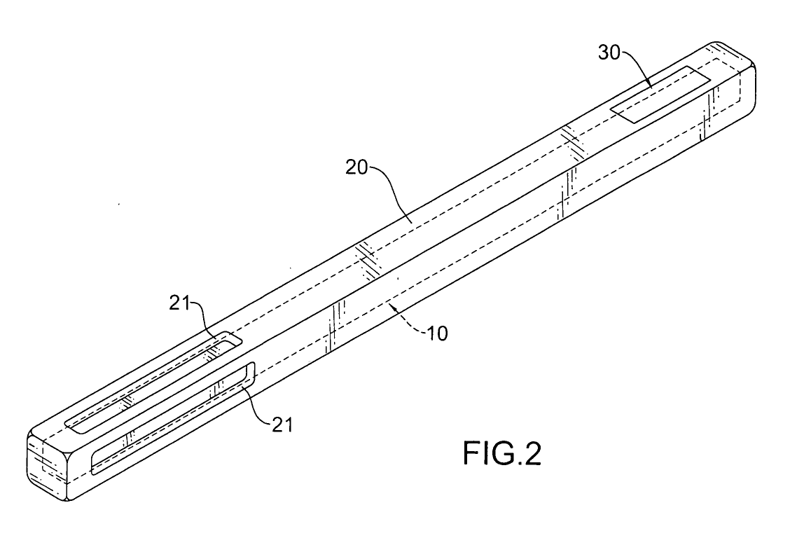

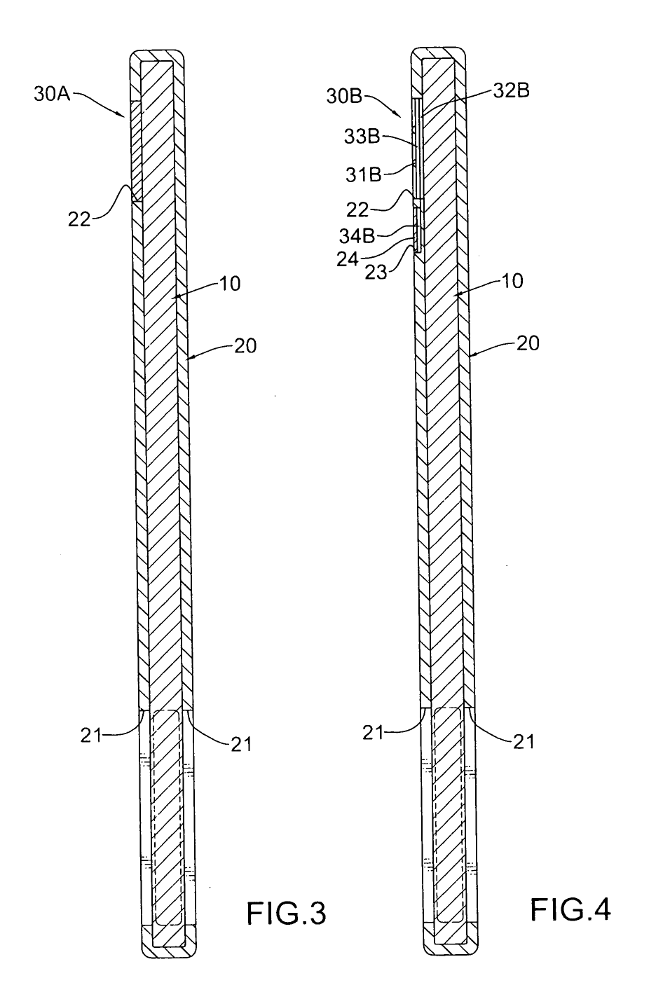

With reference to FIGS. 2 and 3, a second embodiment of the cooling stirrer in accordance with the present invention is similar to the first embodiment and has an adiabatic handle (20A) that covers the whole heat-conductive rod (10) and further has at least one slot (21). The at least one slot (21) is defined through the adiabatic handle (20A) and is located on the lower section of the heat-conductive rod (10). The thermometer (30) is implemented with a color-changing thermometer (30A) having a colored indicator that changes with variation of the temperature of the heat-conductive rod (10).

With reference to FIG. 4, a third embodiment of the cooling stirrer in accordance with the present invention is similar to the second embodiment but the adiabatic handle (20A) further has a battery socket (23) with a cover (24), and the thermometer (30) implemented with a luminous thermometer (30B).

The battery socket (23) is defined in the adiabatic handle (20A) and is adjacent to the mounting hole (22). The cover (24) is mounted detachably on the adiabatic handle (20A) and covers the battery socket (23). The luminous thermometer (30B) has a circuit board (33B), a temperature sensor (32B), at least one light-emitting element (31B) and a battery (34B). The circuit board (33B) is mounted in the mounting hole (22) of the adiabatic handle (20A) and has an inside surface and an outside surface. The temperature sensor (32B) is mounted on the inside surface of the circuit board (33B), is in electrical contact with the circuit board (33B) contacts the heat-conductive rod (10) and senses the temperature of the heat-conductive rod (10). The at least one light-emitting element (31B) is mounted on the outside surface of the circuit board (33B) and is in electrical conduct therewith such that it radiates colored light according to the sensed temperature. The battery (34B) is mounted in the battery socket (23) and is in electrical contact with the circuit board (33B).

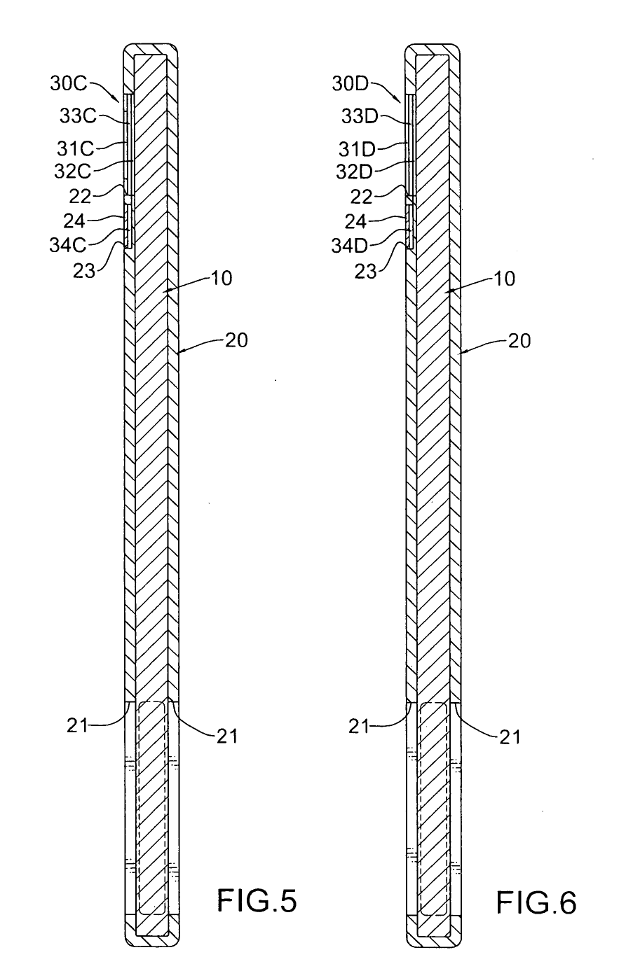

With reference to FIG. 5, a fourth embodiment of the cooling stirrer in accordance with the present invention is similar to the third embodiment and has the thermometer (30) implemented with an audio thermometer (30C). The audio thermometer (30C) has a circuit board (33C), a temperature sensor (32C), an audio element (31C) and a battery (34C).

The circuit board (33C) is mounted in the mounting hole (22) of the adiabatic handle (20A) and has an inside surface and an outside surface. The temperature sensor (32C) is mounted on the inside surface of the circuit board (33C), contacts the heat-conductive rod (10), is in electrical contact with the circuit board (33C) and senses the temperature of the heat-conductive rod (10). The audio element (31C) is mounted on the outside surface of the circuit board (33C), is in electrical contact with the circuit board (33C) and sounds according to the sensed temperature. The battery (34C) is mounted in the battery socket (23) is connected electrically to the circuit board (33C).

With reference to FIG. 6, a fifth embodiment of the cooling stirrer in accordance with the present invention is similar to the third embodiment and has the thermometer (30) implemented with a data-displaying thermometer (30D). The data-displaying thermometer (30D) has a circuit board (33D), a temperature sensor (32D), a data-displaying element (33D) and a battery (34D).

The circuit board (33D) is mounted in the mounting hole (22) of the adiabatic handle (20A) and has an inside surface and an outside surface. The temperature sensor (32D) is mounted on the inside surface of the circuit board (33D), is in electrical contact with the circuit board (33D), contacts the heat-conductive rod (10) and senses the temperature of the heat-conductive rod (10). The data-displaying element (31D) is a liquid crystal display, is mounted on the outside surface of the circuit board (33D), is in electrical contact with the circuit board (33D) and displays a temperature value according to the sensed temperature. The battery (34D) mounted in the battery socket (23) is connected electrically to the circuit board (33D).

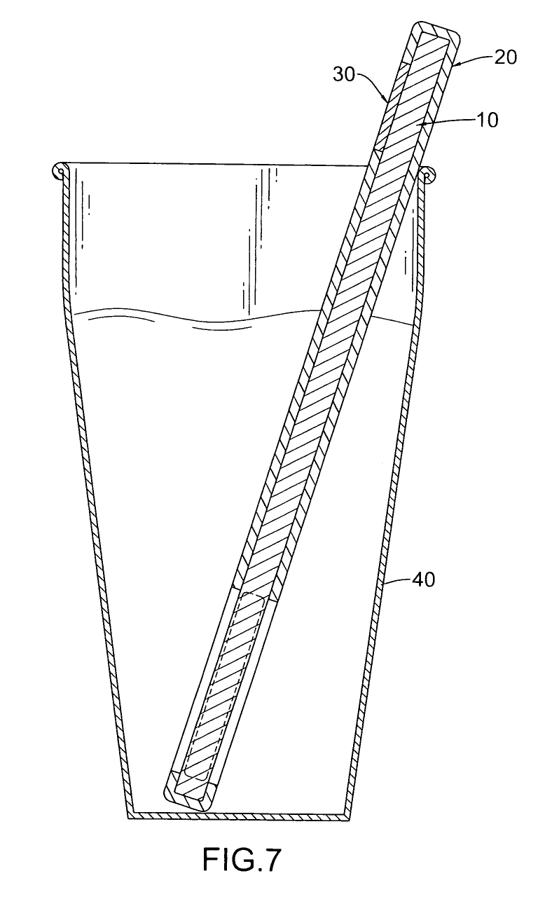

With reference to FIG. 7, the cooling stirrer is used to stir and cool a hot beverage in a cup (40). The adiabatic handle (20A) is held by fingers of a user and prevents the user from being scalded. The lower section of the heat-conductive rod (10) circulates in the hot beverage and absorbs the heat of the beverage so the beverage cools down. The thermometer (30) informs the user the temperature of the hot beverage so that the user can know whether the hot beverage has cooled sufficiently or not.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A cooling stirrer for a hot beverage cup, comprising:
a heat-conductive rod having an upper end, a lower end, an upper section, a lower section and a temperature indicator; and
an adiabatic handle being hollow and mounted on the heat-conductive rod.

2. The cooling stirrer as claimed in claim 1, wherein:
the heat-conductive rod is made of inert metal;
the adiabatic handle is mounted around the upper section of the heat-conductive rod and has a mounting hole defined through the adiabatic handle and located on the upper section of the heat-conductive rod; and
a thermometer is mounted through the adiabatic handle, contacts the heat-conductive rod and senses and displays the temperature of the heat-conductive rod.

3. The cooling stirrer as claimed in claim 1, wherein:
the heat-conductive rod is made of inert metal;
the adiabatic handle is covers the whole heat-conductive rod and has
at least one slot defined through the adiabatic handle and located on the lower section of the heat-conductive rod; and
a mounting hole defined through the adiabatic handle and located on the upper section of the heat-conductive rod; and
a thermometer is mounted through the adiabatic handle, contacts the heat-conductive rod and senses and displays the temperature of the heat-conductive rod.

4. The cooling stirrer as claimed in claim 2, wherein the thermometer is implemented with a color-changing thermometer having a color that changes with variation of the temperature of the heat-conductive rod.

5. The cooling stirrer as claimed in claim 3, wherein the thermometer is implemented with a color-changing thermometer having a color that changes with variation of the temperature of the heat-conductive rod.

6. The cooling stirrer as claimed in claim 2, wherein:
the adiabatic handle further has a battery socket defined in the adiabatic handle adjacent to the mounting hole and a cover mounted detachably on the adiabatic handle and covering the battery socket; and
the thermometer is implemented with a luminous thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
at least one light-emitting element mounted on the outside surface of the circuit board, in electrical contact with the circuit board and radiating color light according to the sensed temperature; and
a battery mounted in the battery socket and in electrical contact with the circuit board.

7. The cooling stirrer as claimed in claim 3, wherein:
the adiabatic handle further has a battery socket defined in the adiabatic handle adjacent to the mounting hole and a cover mounted detachably on the adiabatic handle and covering the battery socket; and
the thermometer is implemented with a luminous thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
at least one light-emitting element mounted on the outside surface of the circuit board, in electrical contact with the circuit board and radiating color light according to the sensed temperature; and
a battery mounted in the battery socket and in electrical contact with the circuit board.

8. The cooling stirrer as claimed in claim 2, wherein:
the adiabatic handle further has a battery socket defined in the adiabatic handle adjacent to the mounting hole and a cover mounted detachably on the adiabatic handle and covering the battery socket; and
the thermometer is implemented with an audio thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
an audio element mounted on the outside surface of the circuit board, in electrical contact with the circuit board and sounding according to the sensed temperature; and
a battery mounted in the battery socket and in electrical contact with the circuit board.

9. The cooling stirrer as claimed in claim 3, wherein:
the adiabatic handle further has a battery socket defined in the adiabatic handle adjacent to the mounting hole and a cover mounted detachably on the adiabatic handle and covering the battery socket; and
the thermometer is implemented with an audio thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
an audio element mounted on the outside surface of the circuit board, and in electrical contact with the circuit board and sounding according to the sensed temperature; and
a battery mounted in the battery socket and in electrical contact with the circuit board.

10. The cooling stirrer as claimed in claim 2, wherein:
the adiabatic handle further has a battery socket defined in the adiabatic handle adjacent to the mounting hole and a cover mounted detachably on the adiabatic handle and covering the battery socket; and
the thermometer is implemented with a data-displaying thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
a data-displaying element mounted on the outside surface of the circuit board, in electrical contact with the circuit board and displaying a temperature value according to the sensed temperature; and
a battery mounted in the battery socket and in electrical contact with the circuit board.

11. The cooling stirrer as claimed in claim 3, wherein:
the adiabatic handle further has a battery socket defined in the adiabatic handle adjacent to the mounting hole and a cover mounted detachably on the adiabatic handle and covering the battery socket; and
the thermometer is implemented with a data-displaying thermometer having
a circuit board mounted in the mounting hole of the adiabatic handle and having an inside surface and an outside surface;
a temperature sensor mounted on the inside surface of the circuit board, in electrical contact with the circuit board, contacting the heat-conductive rod and sensing the temperature of the heat-conductive rod;
a data-displaying element mounted on the outside surface of the circuit board, in electrical contact with the circuit board and displaying a temperature value according to the sensed temperature; and
a battery mounted in the battery socket and in electrical contact with the circuit board.

12. The cooling stirrer as claimed in claim 10, wherein the data-displaying element is a liquid-crystal panel.

13. The cooling stirrer as claimed in claim 11, wherein the data-displaying element is a liquid-crystal panel.
